(19) United States
(12) Patent Application Publication
(10) Pub. No.: US 2009/0149226 A1
(43) Pub. Date: Jun. 11, 2009

(54) INFORMATION PROCESSING APPARATUS

(75) Inventor: Tatsuya WATANABE, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/193,210

(22) Filed: Aug. 18, 2008

(30) Foreign Application Priority Data
Dec. 7, 2007 (JP) P2007-317087

(51) Int. Cl. H04M 1/00

(52) U.S. Cl. 455/575.3

(57) ABSTRACT

An information processing apparatus has a first body and a second body positioned in a plurality of states with respect to the first body, and the gap between the first and second bodies can be determined in a plurality of closed states. A mobile phone as an example of the apparatus includes first and second bodies, and a coupling portion for openably/closably coupling the first body to the second body. The first body has first and second surfaces. The first and second bodies can be placed in the first state that the first surface is closed in proximity to and in confrontation with the second body and in the second state that the second surface is closed in proximity to and in confrontation with the second body, and the gap between the first body and the second body in the first state is different from that in the second state.

### CROSS-REFERENCE TO RELATED APPLICATIONS

This application claims the benefit of priority of Japanese Patent Application No. 2007-317087, filed Dec. 7, 2007, the entire contents of which are incorporated herein by reference.

### BACKGROUND

1. Field

The present invention relates to an information processing apparatus having a first body and a second body positioned in a plurality of states with respect to the first body.

2. Description of the Related Art

Recently, a convertible structure is often employed to an information processing apparatus having a first body and a second body coupled the first body such as a folding-type mobile phone, a notebook type personal computer, and the like.

The information processing apparatus with the convertible structure can position the second body to the first body in at least two types of closed states and one type of an opened state.

An information processing apparatus with the convertible structure, which has an operation unit side body having an operation unit, for example, a keyboard, and the like, a display unit side body having a liquid crystal display screen, and a two-axis rotation hinge for coupling both the bodies, can position the display unit side body to the operation unit side body in two types of closed states, that is, in a first closed state (entirely closed mode) in which the surface of the operation unit side body having the operation unit (operation unit surface) is closed in such a manner that it is covered with the surface of the display unit side body having the liquid crystal display screen (display surface), and in a second closed state in which the operation unit side body is closed in such a manner that the operation unit surface or the back surface of the operation unit surface is closed in such a manner that it is covered with the back surface of the display surface so that at least the liquid crystal display screen is exposed.

A known example of an information processing apparatus having this type of the convertible structure is disclosed in Japanese Unexamined Patent Application Publication No. 2002-198849.

The folding-type wireless communication terminal disclosed in Japanese Unexamined Patent Application Publication No. 2002-198849 has an operation unit side body including an operation unit, a display unit side body including a liquid crystal display screen, and a parallel two-axis hinge and can position the display unit side body to the operation unit side body in two types of closed states, that is, in a first closed state (entirely closed mode) and a second closed state (closed-exposure mode) in which the back surface of the operation unit surface is closed in such a manner that it is covered with the back surface of the operation unit surface so that the operation unit and the liquid crystal display screen are exposed.

The folding-type wireless communication terminal is very convenient because when it is used in the closed-exposure mode, i.e., in a folded state, the display unit can be observed as well as the operation unit can be used.

In the conventional information processing apparatuses having the convertible structure, the gap between the display unit side body and the operation unit side body is designed so that it is unchanged in the first closed state and the second closed state and the gap is made as small as possible. This is effective to improve an accommodation property and a portable property.

However, as technologies are developed, it is considered that it is not preferable that the gap between the display unit side body and the operation unit side body is simply narrow and that it is more preferable that the gap is different in the first closed state and the second closed state as a mode of use of the information processing apparatus having the convertible structure.

Recently, as the technologies are developed, many mobile phones are provided with a TV audio-visual function. However, in, for example, a mobile phone having the conventional parallel two-axis hinge, when speaker holes are formed to the back surface of the operation unit surface or to the back surface of the display surface, a sound issued from a speaker is boxed in when TV is observed in the closed-exposure mode. In this case, the gap between the display unit side body and the operation unit side body is preferably narrow in the entirely closed mode in consideration of the portable property, whereas it is preferably wide in the closed-exposure mode in consideration of convenience when TV is observed.

### SUMMARY OF THE INVENTION

The present invention has been made in light of the above situation, and accordingly it is an object of the present invention to provide an information processing apparatus with a convertible structure having a first body and a second body which is positioned in a plurality of states with respect to the first body, and the first body can be positioned in a plurality of closed states in which the gaps between the first body and the second body are different.

To solve the problems described above, an information processing apparatus according to one aspect of the present invention is an information processing apparatus, includes a first body having a first surface and a second surface as the back surface of the first surface; a second body having a third surface and a fourth surface as the back surface of the third surface; and a coupling portion configured to couple the first body with the second body so that the information processing apparatus takes an opened state and at least two closed states by rotating the first body about a first axis and a second axis which is parallel to the first axis, wherein the first axis and the second axis are parallel to the first surface, the second surface, the third surface, and the fourth surface; the first axis is positioned to pass through the first body and the second axis is positioned to pass through the second body, respectively; a first state of the closed states is the state in which the first surface is positioned in proximity to and in confrontation with the third surface and the first surface is approximately parallel to the third surface, and a second state of the closed states is the state in which the second surface is positioned in proximity to and in confrontation with the fourth surface and the second surface is approximately parallel to the fourth surface; and the distance from the first surface to the third surface in the first state is different from the distance from the second surface to the fourth surface in the second state.

Further, to solve the problems described above, an information processing apparatus according to another aspect of the present invention is an information processing apparatus, includes a first body having a first surface and a second surface as the back surface of the first surface; a second body having a third surface and a fourth surface as the back surface of the third surface; and a coupling portion configured to couple the first body with the second body so that the information processing apparatus taxes an opened state and at least two closed states by rotating the first body about a first axis and a second axis orthogonal to the first, axis; wherein a first state of the closed states is the state in which the first surface is positioned in proximity to and in confrontation with the third surface and the first surface is approximately parallel to the third surface, and a second state of the closed states is the state in which the second surface is positioned in proximity to and in confrontation with the third surface and the second surface is approximately parallel to the third surface; and the distance from the first surface to the third surface in the first state is different from the distance from the second surface to the third surface in the second state.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIGS. 1A to 1C are schematic outside appearance views of a mobile phone in the state that the mobile phone is in an opened state (open mode) according to a first embodiment of the present invention;

FIGS. 2A and 2B are explanatory views showing an example of the outside appearance of the mobile phone in an entirely closed state;

FIGS. 3A and 3B are outside appearance views of the mobile phone in the state that the mobile phone is in an closed-exposure mode;

FIG. 4 is a view explaining the thicknesses of respective portions of the mobile phone according to the embodiment in the entirely closed mode using a right side elevational view;

FIG. 5 is a view explaining an example of a coupling portion of the mobile phone according to the embodiment using the right side elevational view in the open mode;

FIG. 6 is a view explaining other example of the coupling portion of the mobile phone according to the embodiment using the right side elevational view in the open mode;

FIGS. 7A and 7B are right side elevational views explaining the difference of the gaps between a first body and a second body in the entirely closed mode (first state) and in the closed-exposure mode (second state) when only the distance from a second rotation axis surface to a fourth surface is reduced;

FIGS. 8A and 8B are right side elevational views explaining the difference of the gap between the first body and the second body in the entirely closed mode (first state) and in the closed-exposure mode (second state) when only the distance from a first rotation axis surface to a second surface is reduced;

FIGS. 9A and 9B are outside appearance views of a modification of the first body and the second body of the mobile phone shown in FIGS. 1A to 1C in the entirely closed mode;

FIGS. 10A and 10B are outside appearance views of the modification of the first body and the second body shown in FIGS. 1A to 1C in the closed-exposure mode;

FIG. 11 is a schematic perspective view showing a mobile phone in an opened state (open mode) according to a second embodiment of the present invention;

FIG. 12 is a view explaining the thicknesses of respective portions of the mobile phone according to the second embodiment using the right side elevational view in the entirely closed mode; and

FIG. 13 is a view explaining the thicknesses of the respective portions of the mobile phone according to the second embodiment using the right side elevational view in a semi-closed-exposure mode.

### DETAILED DESCRIPTION

Hereinbelow, a description will be given of an information processing apparatus, according to an embodiment of the present invention with reference to the drawings.

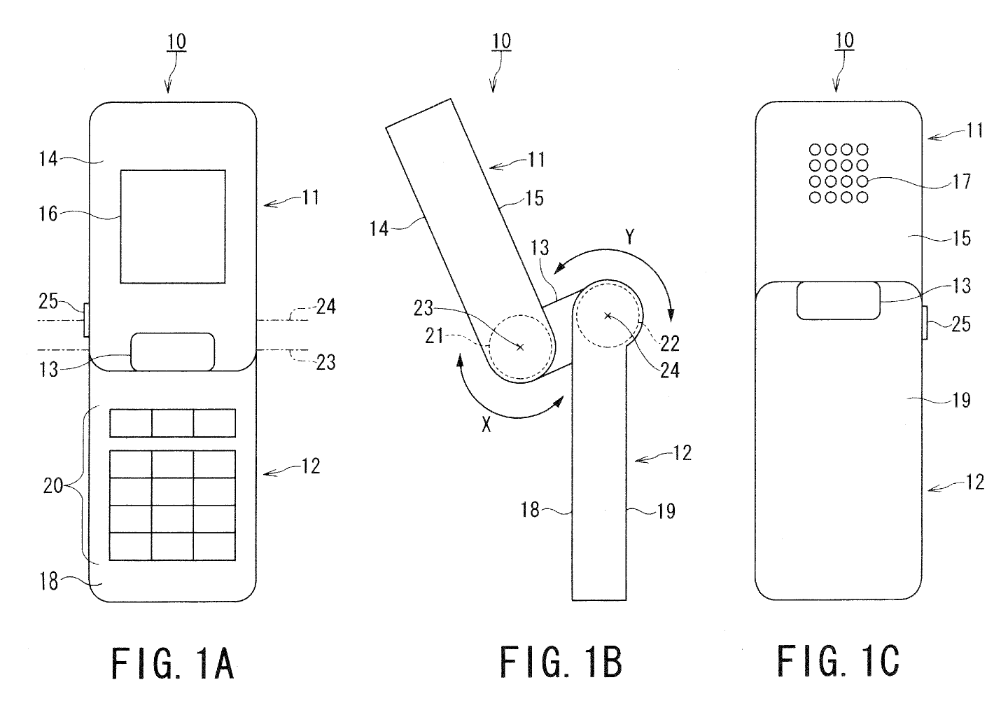

FIGS. 1A to 1C are schematic outside appearance views of a mobile phone in the state that the mobile phone is in an opened state (open mode) according to a first embodiment of the present invention

With the explanation of the present embodiment, a mobile phone having a parallel two-axis hinge will be shown as an example of an information processing apparatus.

FIG. 1A shows an outside appearance view of the mobile phone 10 in an opened state observed from a front surface. FIG. 1B shows an outside appearance view thereof observed from a right side surface. FIG. 1C shows an outside appearance view thereof observed from, a back surface, respectively.

The mobile phone 10 has a first body 11, a second body 12, and a coupling portion 13 for openably/closably coupling the first body 11 with the second body 12.

The first body 11 has a first surface 14 and a second surface 15 as the back surface of the first surface 14. A display unit 16 is disposed to the first surface 14 (refer to FIG. 1A). Speaker holes 17 are formed to the second surface 15 to output a sound from a speaker (refer to FIG. 1C).

The second body 12 has a third surface 18 and a fourth surface 19 as the back surface of the third surface 18. An operation unit 20 is disposed to the third surface 18.

The display unit 16 is composed of an ordinary display output device, for example, a liquid crystal display, an OLED (Organic Light Emitting Device) display, and the like and displays the background image (wall paper) of the display unit 16, various icons such as images and the like, which schematically show a battery remaining amount, radio wave intensity, and images and pictures displayed when a call arrives. These icons, images, and the pictures will be shown by being overlapped on the wall paper.

The operation unit 20 is composed of an ordinary input device, for example, a keyboard, a touch panel, ten keys, and the like and outputs an operation input signal in response to a user's operation.

As shown in FIG. 1B, a first rotation unit 21 and a second rotation unit 22 are fixed to the ends of the first body 11 and the second body 12, respectively. The first rotation unit 21 rotates in the direction of an arrow X about a first axis 23. The second, rotation unit 22 rotates in the direction of an arrow Y about a second axis 24. Note that cross marks in the figure are virtual marks showing the positions of the first axis 23 and the second axis 24.

The first axis 23 and the second axis 24 are parallel to all the first, second, third, and fourth surfaces 14, 15, 18, and 19. Further, the first axis 23 is located to pass through the first body 11 and the second axis 24 is located to pass through the second body 12, respectively.

The coupling portion 13 couples the first rotation unit 21 with the second rotation unit 22 so that they can independently rotate. In the following explanation, an example, in which the distance from the first axis 23 to the second axis 24 is not changed on a plane parallel to the longitudinal cross section of the mobile phone 10 (refer to FIG. 1B), will be explained.

The second rotation unit 22 has a lock mechanism for regulating rotation in addition to a rotation mechanism. When a rotation regulating function is applied by the lock mechanism, the second rotation unit 22 is not allowed to rotate. The rotation regulating function can be released in response to an operation performed by the user. In the following explanation, an example will be shown in which a lock release button 25 for releasing the rotation regulating function is disposed to the left side surface of the second body 12 as shown in FIG. 1C and the rotation regulating function is released while the lock release button 25 is being depressed.

The first body 11 can be positioned in an opened state (open mode) with respect to the second body 12. Further, the first body 11 can be positioned in two closed states with respect to the second body 12, that is, in an entirely closed mode as a first state and a closed-exposure mode as a second state.

FIGS. 1A to 1C show an example of the mobile phone 10 in the open mode. In the following explanation, it is assumed that the open mode means the state in which the position of the first body 11 to the second body 12 is a position at which the mobile phone 10 is used as an ordinarily mobile phone.

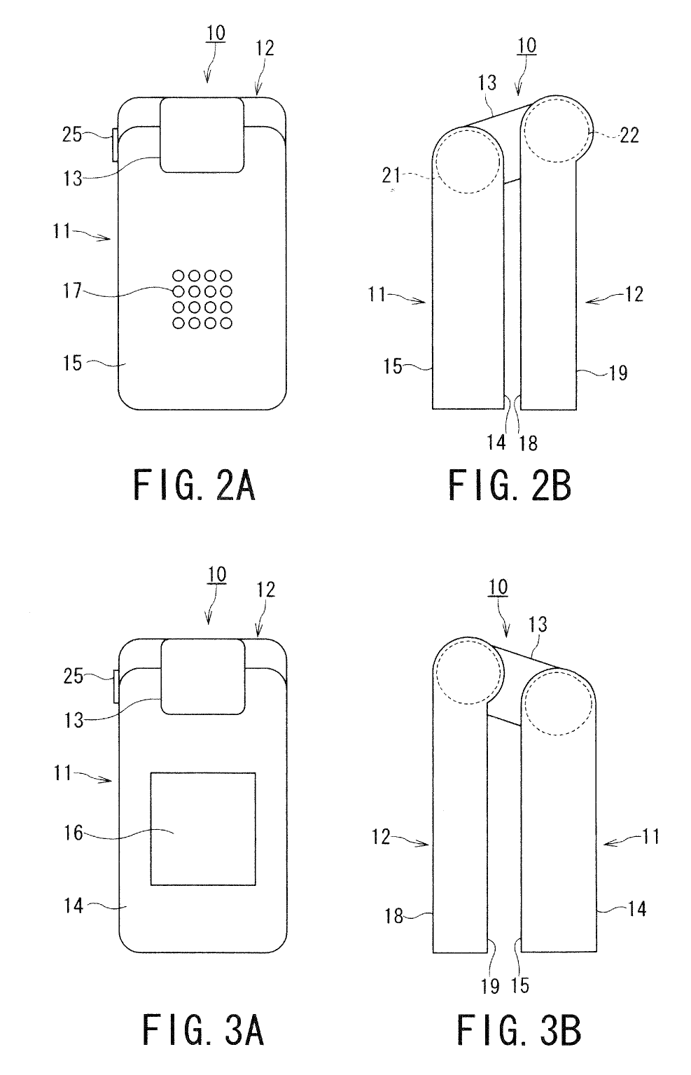

FIGS. 2A and 2B are explanatory views showing an example of the outside appearance of the mobile phone 10 in the entirely closed mode. FIG. 2A shows an outside appearance view of the mobile phone 10 observed from a front surface in the entirely closed mode. FIG. 2B shows an outside appearance view thereof observed from a right side surface, respectively.

In the following explanation, it is assumed that the entirely closed mode means the state in which the first surface 14 and the third surface 18 are positioned in approximately parallel to each other (refer to FIG. 2B) in such a manner that they are closed in proximity to and in confrontation with each other by rotating the first body 11 from the open mode (refer to FIG. 1B) about the first axis 23 in the direction of the arrow X.

FIGS. 3A and 3B are explanatory views showing an example of the outside appearance of the mobile phone 10 in the closed-exposure mode. FIG. 3A shows an outside appearance view of the mobile phone 10 observed from the front surface in the closed-exposure mode. FIG. 3B is an outside appearance view thereof observed from the right side surface, respectively.

In the following explanation, it is assumed that the closed-exposure mode means the state in which the second surface 15 and the fourth surface 19 are positioned in approximately parallel to each other (refer to FIG. 3B) in such a manner that they are closed in proximity to and in confrontation with each other by rotating the second body 12 from the open mode (refer to FIG. 1B) about the second axis 24 in the direction of the arrow Y. It must be noted that the lock release button 25 must be depressed to rotate the second body 12 about the second axis 24 in the direction of the arrow Y.

Next, an example of an operation of the information processing apparatus according to the embodiment will be explained. In the example explained below, the gap between the first body 11 and the second body 12 in the closed state is wider in the closed-exposure mode (second state) than in the entirely closed mode (first state).

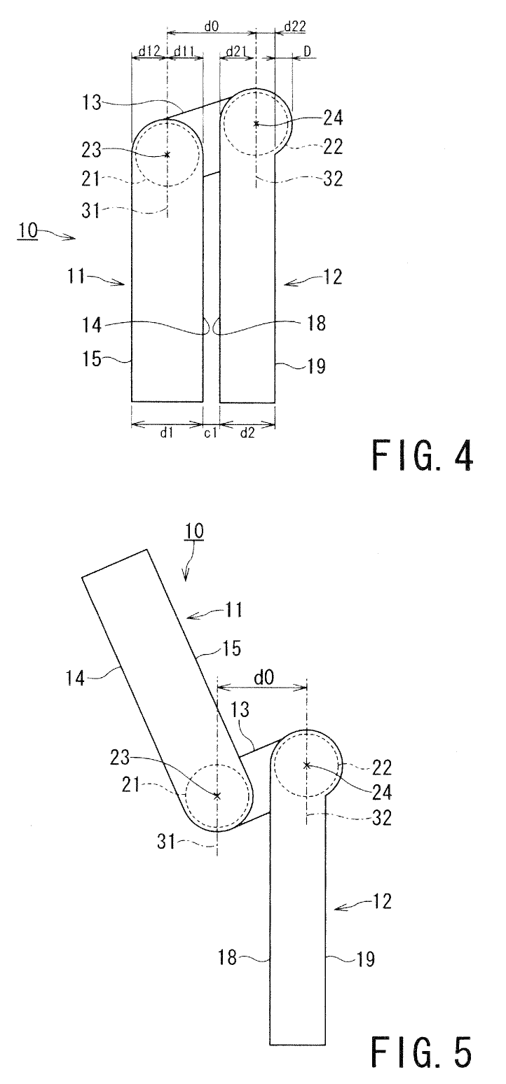

FIG. 4 is a view explaining the thicknesses of respective portions of the mobile phone 10 according to the embodiment using the right side elevational view in the entirely closed mode.

Conventionally, in the information processing apparatus which can be placed in the two closed states, the gap between the first body and the second body 12 is designed so that it is approximately unchanged in the two closed states and the gap is made as small as possible. However, it is also considered a mode of use in which it is preferable that the gap between the first body 11 and the second body 12 is different in the two closed states.

As the mode of use, there is, for example, exemplified a mode in which speaker holes 17 are formed to the second surface 15 of the first body 11 or to the fourth surface 19 of the second body 12 and TV is observed in the closed-exposure mode. In this case, the gap between the first body 11 and the second body 12 is preferably narrow in the entirely closed mode in consideration of a portable property, whereas it is preferably wider in the closed-exposure mode than in the entirely closed mode in consideration of convenience when TV is observed.

As shown in FIG. 4, the thickness d1 of the first body 11 of the mobile phone 10 is the sum of the distance d11 from the first surface 14 to a first rotation axis surface 31, which includes the first axis 23 and is parallel to the second surface 15, and the distance d12 from the second surface 15 to the first rotation axis surface 31. Further, the thickness d2 of the second body 12 is the sum of the distance d21 from the third surface 18 to a second rotation axis surface 32, which includes the second axis 24 and is parallel to the fourth surface 19, and the distance d22 from the fourth surface 19 to the second rotation axis surface 32.

Note that the embodiment will show an example in which d11, d12, and d21 are equal to each other and d22 is smaller than d11, d12, and d21 by a distance D.

The gap (clearance) c1 between the first body 11 and the second body 12 in the entirely closed mode is equal to the distance between the first surface 14 and the third surface 18. The distance c1 between the first surface 14 and the third surface 18 in the entirely closed mode is obtained by subtracting all and d21 from the distance d0 from she first rotation axis surface 31 to the second rotation axis surface 32 (c1=d0−(d11−d21)).

FIG. 5 is a view explaining an example of the coupling portion 13 of the mobile phone 10 according to the embodiment using the right side elevational view in the open mode.

As apparent from the comparison of FIG. 4 with FIG. 5, the entirely closed mode can be shifted to the open mode only by the rotation about the first axis 23. At the time, the lock release button 25 does not need to be depressed. The positions of the first axis 23 and the second axis 24 are not changed from the entirely closed mode to the open mode. Accordingly, the distance d0 from the first rotation axis surface 31 to the second rotation axis surface 32 is not also changed.

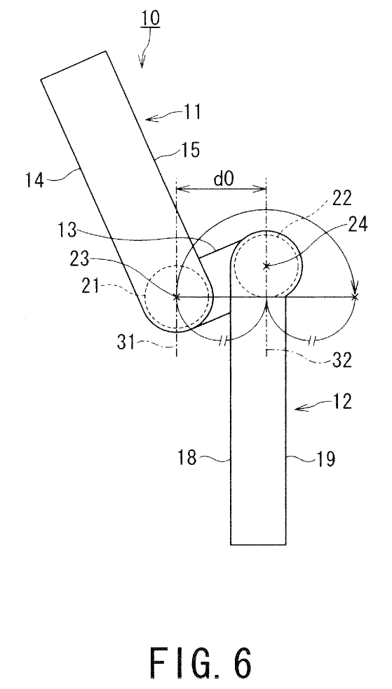

FIG. 6 is a view explaining other example of the coupling portion 13 of the mobile phone 10 according to the embodiment using the right side elevational view in the open mode.

As shown in FIG. 6, the open mode can be shifted to the closed-exposure mode only by the rotation about the second axis 24. At the time, the lock mechanism release button is depressed. When the open mode is shifted to the closed-exposure mode, the first axis 23 rotates about the second axis 24. As a result, the first axis 23 moves to the position at which it is surface symmetrical (mirror symmetrical) to the second rotation axis surface 32. Accordingly, the distance from the first rotation axis surface 31 to the second rotation axis surface 32 in the closed-exposure mode is equal to the distance d0 in the entirely closed mode.

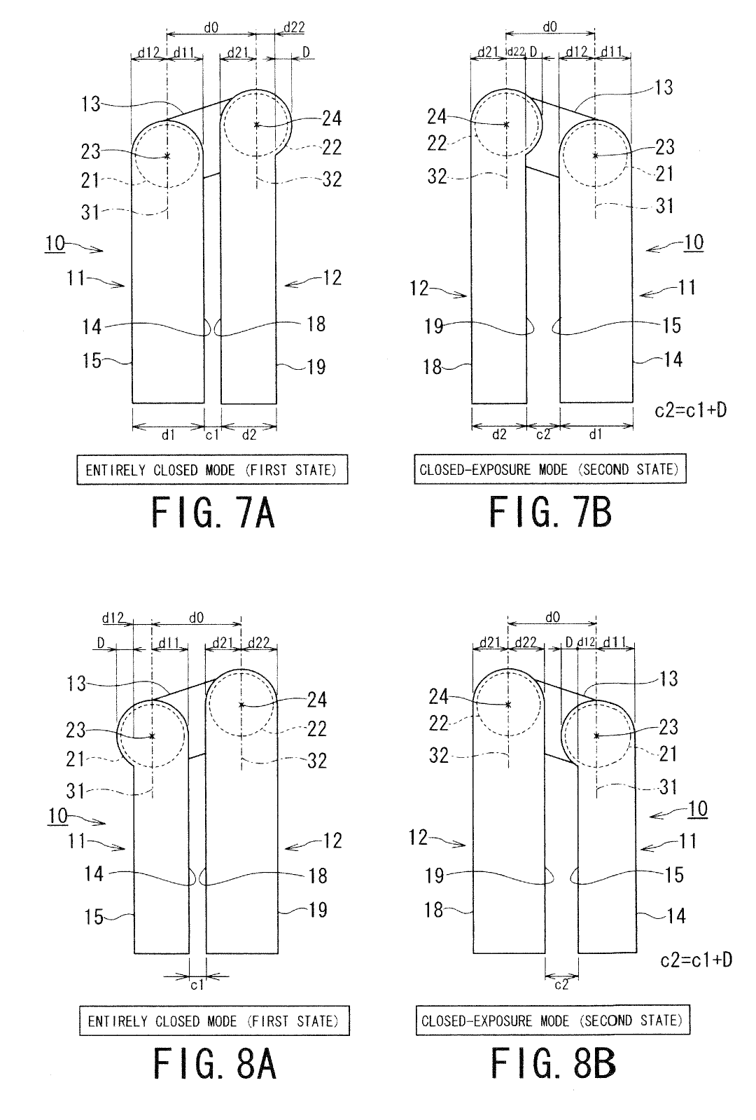

FIGS. 7A and 7B are right side elevational views explaining the difference of the gaps between the first body 11 and the second body 12 in the entirely closed mode (first state) and in the closed-exposure mode (second state) when only the distance d22 from the second rotation axis surface 32 to the fourth surface 19 is reduced.

FIG. 7A is a right side elevational view explaining the gaps between the first body 11 and the second body 12 in the entirely closed mode (first state). FIG. 7B is a right side elevational view explaining the gaps between the first body 11 and the second body 12 in the closed-exposure mode (second state).

As shown in FIG. 7B, the gap (clearance) c2 between the first body 11 and the second body 12 in the closed-exposure mode is equal to the distance between the second surface 15 and the fourth surface 19. The distance c2 between the second surface 15 and the fourth surface 19 in the closed-expo sure mode is the distance obtained by subtracting d12 and d22 from the distance d0 from the first rotation axis surface 31 to the second rotation axis surface 32 (c2=d0−(d12+d22)).

All the distances d11, d12, and d21 are equal to each other, and d22 is smaller than d11, d12, and d21 by the distance D (d11=d12=d21=d22+D). Accordingly, c2 is wider than c1 by D (c2=c1+D).

When the distance d0 between the first rotation axis surface 31 and the second rotation axis surface 32 does not change in the two closed states, the gap between the first body 11 and the second body 12 is determined by the sum of d11 and d21 in the entirely closed mode. Further, the gap is determined by the sum of d12 and d22 in the closed-exposure mode.

Accordingly, the gaps between the first body 11 and the second body 12 (c1 and c2) in the two closed states can be made different from each other by forming the first body 11 and the second body 12 so that the sum of d11 and d21 is different from the sum of d12 and d22.

When, for example, it is desired to make the gap c2 in the closed-exposure mode larger than the gap c1 in the entirely closed mode, it is sufficient to make the sum of d11 and d21 larger than the sum of d12 and d22.

In the above explanation, the example for making only d22 smaller is explained as an example for making c2 larger than c1. However, it is needless to say that c2 can be made larger than c1 by reducing only d12, and further making both d12 and d22 smaller than d11 and d21 likewise.

FIGS. 8A and 8B are right side elevational views explaining the difference of the gap between the first body 11 and the second body 12 in the entirely closed mode (first state) and in the closed-exposure mode (second state) when only the distance d12 from the first rotation axis surface 31 to the second surface 15 is reduced;

FIG. 8A is a right side elevational view explaining the gaps between the first body 11 and the second body 12 in the entirely closed mode (first state). FIG. 8B is a right side elevational view explaining the gaps between the first body 11 and the second body 12 in the closed-exposure mode (second state).

As shown in FIGS. 8A and 8B, when only d12 is reduced (d11=d12+D=d21=d22), it is also possible to make the gap c2 (c2=d0−(d12+d22)) between the first body 11 and the second body 12 in the closed-exposure mode larger than the gap c1 (c1=d0−(d11+d21)) between the first body 11 and the second body 12 in the entirely closed mode (C2=c1+D) likewise the case in which only d22 is reduced.

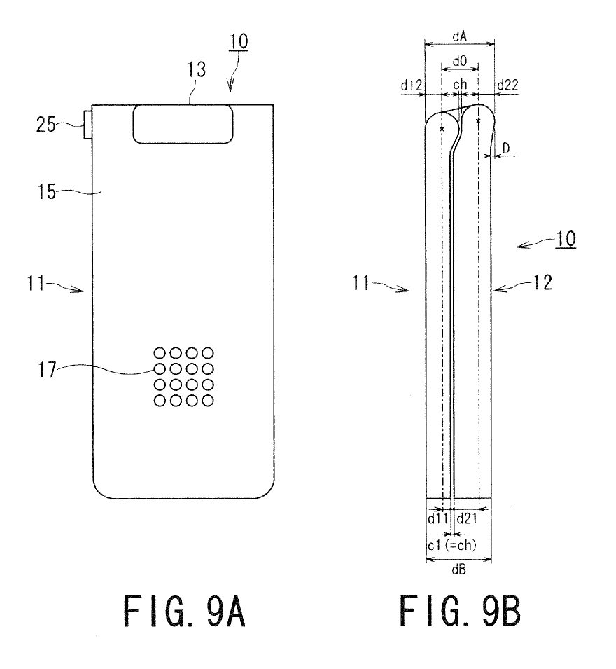

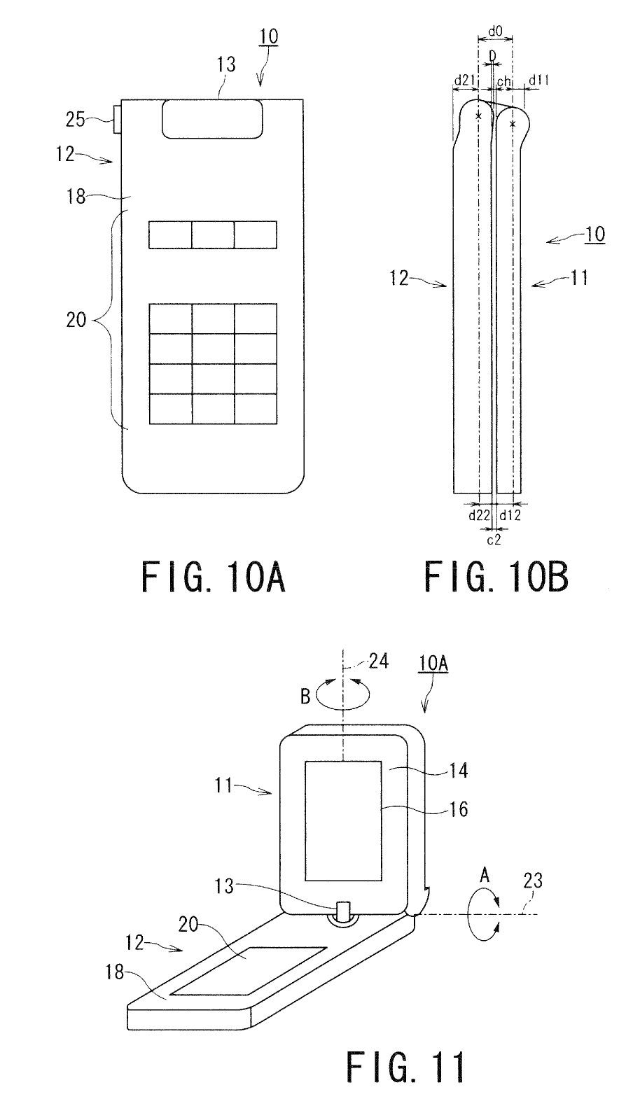

FIGS. 9A and 9B, and FIGS. 10A and 10B, are views showing a modification of the first body 11 and the second body 12 of the mobile phone 10 shown in FIGS. 1A to 1C. FIG. 9A is an outside appearance view of the modification of the first body 11 and the second body 12 of the mobile phone 10 when they are observed from the front surface in the entirely closed mode, and FIG. 9B is an outside appearance view thereof when they are observed from the right side surface. FIG. 10A is an outside appearance view of the modification of the first body 11 and the second body 12 of the mobile phone 10 when they are observed from the front surface in the closed-exposure mode, and FIG. 10B is an outside appearance view of the modification when they are observed from, the right side surface.

As shown in FIGS. 9B and 10B, even if the shapes of the first body 11 and the second body 12 are changed m the vicinity of the coupling portion 13, the gap c1 in the entirely closed mode can be shown by c1=d0−(d11+d21), and the gap c2 in the closed-exposure mode can be shown by c2=d0−(d12+d22).

The modification shown in FIGS. 9A, 9B, 10A and 10B show an example in which the gap c1 in the closed mode is equal to the gap ch at the coupling portion 13 (c1=ch). Further, the modification shows an example in which the second body 12 is formed so that the thickness dA of the coupling portion 13 is made thicker than the thickness dB of the main portion by D (dA=dB+D).

As shown in FIG. 10B, in the modification, the gap c2 in the closed-exposure mode is equal to the size obtained by adding D to the gap ch of the coupling portion 13 (c2−ch+D=c1+D). Accordingly, the gaps c1 and c2 between the first body 11 and the second body 12 in the two closed states can be made different from each other even by the modification shown in FIGS. 9A, 9B, 10A and 10B.

In the mobile phone 10 according to the embodiment, the first body 11 and the second body 12 are formed so that the sum of the distance d11 from the first rotation axis surface 31 to the first surface 14 and the distance d21 from the second rotation axis surface 32 to the third surface 18 is different from the sum of the distance d12 from the first rotation axis surface 31 to the second surface 15 and the distance d22 from the second rotation axis surface 32 to the fourth surface 19. Thus, according to the mobile phone 10 of the embodiment, the first body 11 can be positioned in the plurality of closed states in which the gaps between the first body 11 and the second body 12 are different from each other.

When the distance between the first rotation axis surface 31 and the second rotation axis surface 32 is the same in the closed states, the gap c1 in the entirely closed mode can be expressed as c1=d0−(d11+d21), and the gap c2 in the closed-exposure mode can be expressed as c2=d0−(d12+d22). Accordingly, c1 has only the sum of d11 and d21 as a variable, and c2 has only the sum of d12 and d22 as a variable. As a result, desired gaps can be easily obtained in the respective closed states by appropriately adjusting the sum of d11 and d21 and the sum of d12 and d22.

When, for example, the sum of d12 and d22 is made smaller than the sum of d11 and d21 and c2 is made larger than c1, boxing of a sound can be reduced in the mode of use in which the speaker holes 17 are formed to the first surface 14 or the fourth surface 19 and a sound is output from the speaker in the closed-exposure mode, as well as the thicknesses of the main portions can be reduced in the closed mode, which is very convenient. Further, since a clearance can be secured in the closed-exposure mode, a radiation efficiency can be improved in the closed-exposure mode.

Further, when the sum d12 and d22 is made larger than the sum of d11 and d21 and c1 is made larger than c2, even if the keys of the operation unit 20 are more projected than conventional ones, since the projecting keys are not in touch with the first surface 14 in the entirely closed mode, the operation unit 20 can be arranged user-friendly even to a user who is unaccustomed to a key operation.

Next, a second embodiment of the information processing apparatus according to the present invention will be explained.

FIG. 11 is a schematic perspective view showing a mobile phone 10A in an opened state (open mode) as the information processing apparatus according to a second embodiment of the present invention.

The mechanism of a coupling portion 13 of the mobile phone 10A shown in the second embodiment is different from that of the mobile phone 10 shown in the first embodiment. Since the other arrangements and the operation of the second embodiment are not substantially different from those of the mobile phone 10 shown in FIG. 1, the same arrangements are denoted by the same reference numerals and the explanation thereof is omitted.

A first body 11 is coupled with a second body 12 through the coupling portion 13 so that it can be opened and closed in the direction of an arrow A about a first axis 23 as well as can be rotated in the direction of an arrow B about a second axis 24.

The first body 11 can be positioned with respect to the second body 12 in an opened state (open mode) and two closed states. As to the closed states, the first body 11 can be positioned in the entirely closed mode as a first state and in a semi-closed exposure mode as a second stare.

It is assumed that the semi-closed exposure mode (second state in the embodiment) means the state in which the second surface 15 is closed in proximity to and in confrontation with a third surface 18 and the second surface 15 and the third surface 18 are positioned approximately in parallel to each other. The open mode (see FIG. 11) can be shifted to the semi-closed exposure mode by rotating at first the first body 11 in the direction of an arrow B 180° about the second axis 24 and then closing it in the direction of an arrow A about the first axis 23. At the time, although an operation unit 20 is covered with the first body 11 and is not exposed, a display unit 16 is exposed.

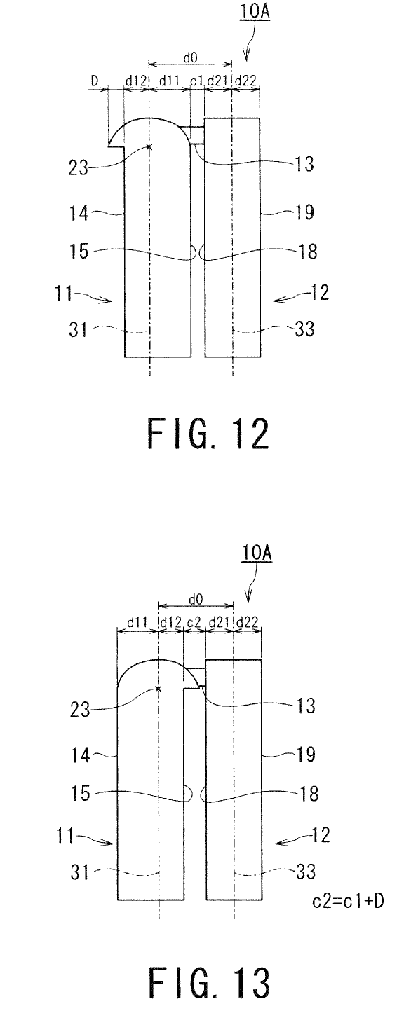

FIG. 12 is a view explaining the thicknesses of the respective portions of the mobile phone 10A according to the second embodiment using a right side elevational view in the entirely closed mode. Further, FIG. 13 is a view explaining the thicknesses of respective portions of the mobile phone 10A according to the second embodiment using a right side elevational view in the semi-closed exposure mode.

Note that the second rotation axis surface 32 cannot be defined likewise the first embodiment in the second embodiment. Accordingly, the second embodiment will be explained using a second body center surface (the center surface of the second body) 33 in place of the second rotation axis surface 32.

As shown in FIG. 12, the gap (clearance) c1 between the first body 11 and the second body 12 in the entirely closed mode is equal to the distance between a first surface 14 and the third surface 18 also in the embodiment likewise the first embodiment. The distance c1 between the first surface 14 and the third surface 18 in the entirely closed mode is the distance which is obtained by subtracting d11 and d21 from the distance d0 from a first rotation axis surface 31 to a second body center surface 33 (c1=d0−(d11+d21)).

Further, as shown in FIG. 13, the gap (clearance) c2 between the first body 11 and the second body 12 in the semi-closed exposure mode is equal to the distance between the second surface 15 and the third surface 18. The distance c2 between the second surface 15 and a fourth surface 19 in the semi-closed exposure mode is the distance obtained by subtracting d12 and d21 from the distance d0 from the first rotation axis surface 31 to the second body center surface 33 (c2=d0−(d12+d21)).

Accordingly, when the distance d0 between the first rotation axis surface 31 and the second rotation axis surface 33 does not change in the two closed states, the gap between the first body 11 and the second body 12 is determined by d11 in the entirely closed mode and determined by d12 in the semi-closed exposure mode.

Accordingly, the gaps (c1 and c2) between the first body 11 and the second body 12 in the two closed states can be made different from each other by forming the first body 11 so that d11 is different from d12.

When, for example, it is desired to make the gap c2 in the semi-closed exposure mode than the gap c1 in the entirely closed mode, it is sufficient to make d11 larger than d12 as shown FIG. 11 to FIG. 13.

In the mobile phone 10A according to the embodiment, the first body 11 is formed so that, the distance d11 from the first rotation axis surface 31 to the first surface 14 is different from the distance d12 from the first rotation axis surface 31 to the second surface 15. Thus, according to the mobile phone 10A of the embodiment, the first body 11 can be positioned in a plurality of closed states in which and the first body 11 and the second body 12 have a different gap.

When the distances between the first rotation axis surface 31 and the second body center surface 33 are the same in the closed states, the gap c1 in the entirely closed mode can be expressed as c1=d0−(d11+d21) and the gap c2 in the semi-closed exposure mode can be expressed as c2=d0−(d12+d21). Accordingly, c1 is determined only from d11 and c2 is determined only from d12. As a result, desired gaps can be easily obtained, in the respective closed states by appropriately adjusting d11 and d12.

Note that the present invention is not limited to the embodiments as chey are and can be specifically realized by modifying the components thereof within the scope which does not depart from the gist of the embodiments when they are embodied. Further, various inventions can be created by appropriately combining the plurality of components disclosed in the embodiments. For example, several components may be deleted from all components shown in the embodiments. The components used in different embodiments may be appropriately combined.

Further, the present invention can be applied to all the convertible type information processing apparatuses having a first body and a second body positioned in a plurality of closed states with respect to the first body and can be applied to mobile information processing apparatuses, for example, a notebook type personal computer, a PDA (Personal Digital Assistant), a mobile game machine, a mobile music player, a mobile motion picture player, and the like.

What is claimed is:

1. An information processing apparatus comprising:
a first body having a first surface and a second surface as the back surface of the first surface;
a second body having a third surface and a fourth surface as the back surface of the third surface; and
a coupling portion configured to couple the first body with the second body so that the information processing apparatus takes an opened state and at least two closed states by rotating the first body about a first axis and a second axis which is parallel to the first axis,
wherein the first axis and the second axis are parallel to the first surface, the second surface, the third surface, and the fourth surface;
the first axis is positioned to pass through the first body and the second axis is positioned to pass through the second body, respectively;
a first state of the closed states is the state in which the first surface is positioned in proximity to and in confrontation with the third surface and the first surface is approximately parallel to the third surface, and a second state of the closed states is the state in which the second surface is positioned in proximity to and in confrontation with the fourth surface and the second surface is approximately parallel to the fourth surface; and
the distance from the first surface to the third surface in the first state is different from the distance from the second surface to the fourth surface in the second state.

2. The information processing apparatus according to claim 1, wherein the first body and the second body are formed so that the sum of the distance from the first surface to a first rotation axis surface, which includes the first axis and is parallel to the second surface, and the distance from the third surface to a second rotation axis surface, which includes the second axis and is parallel to the fourth surface, is different from the sum of the distance from the second surface to the first rotation axis surface and the distance from the fourth surface to the second rotation axis surface.

3. The information processing apparatus according to claim 2, wherein the first body and the second body are formed so that the sum of the distance from the second surface to the first rotation axis surface and the distance from the fourth surface to the second rotation axis surface is smaller than the sum of the distance from the first surface to the first rotation axis surface and the distance from the third surface to the second rotation axis surface.

4. The information processing apparatus according to claim 1, wherein at least one of the second surface and the fourth surface has holes, through which a speaker outputs a sound.

5. An information processing apparatus comprising:
a first body having a first surface and a second surface as the back surface of the first surface;
a second body having a third surface and a fourth surface as the back surface of the third surface; and
a coupling portion configured to couple the first body with the second body so that the information processing apparatus takes an opened state and at least two closed states by rotating the first body about a first axis and a second axis orthogonal to the first axis;
wherein a first state of the closed states is the state in which the first surface is positioned in proximity to and in confrontation with the third surface and the first surface is approximately parallel to the third surface, and a second state of the closed states is the state in which the second surface is positioned in proximity to and in confrontation with the third surface and the second surface is approximately parallel to the third surface; and
the distance from the first surface to the third surface in the first state is different from the distance from the second surface to the third surface in the second state.

6. The information processing apparatus according to claim 5, wherein the first body is formed so that the distance from the first surface to a first rotation axis surface, which includes the first axis and is parallel to the second surface, is different from the distance from the second surface to the first rotation axis surface.

7. The information processing apparatus according to claim 5, wherein the first body is formed so that the distance from the second surface to the first rotation axis surface is shorter than the distance from the first surface to the first rotation axis surface.
